(19) United States
(12) Patent Application Publication
(10) Pub. No.: US 2023/0177435 A1
(43) Pub. Date: Jun. 8, 2023

(54) MODULARIZED GOVERNANCE OF CONTINUOUS COMPLIANCE

(71) Applicant: International Business Machines Corporation, Armonk, NY (US)

(72) Inventors: Anca Sailer, Scarsdale, NY (US); Christopher John Butler, Hawthorne East (AU); Arun Kumar, Noida (IN); Malgorzata Steinder, Leonia, NJ (US)

(73) Assignee: International Business Machines Corporation, Armonk, NY (US)

(21) Appl. No.: 17/541,344

(22) Filed: Dec. 3, 2021

(51) Int. Cl. G06Q 10/06; G06F 21/57

(52) U.S. Cl. CPC G06Q 10/0635; G06Q 10/0637; G06F 21/57; G06F 2221/034

(57) ABSTRACT

A method, apparatus and computer program product for automated security and regulatory compliance in association with an enterprise. A set of security and compliance controls that operate in association with the enterprise are provided. One or more compliance policies that are enforced by the set of security and compliance controls are encapsulated according to a common data format. One or more customer-specific security/compliance requirements associated with the enterprise are collected. Using microservices-based modular components, the customer-specific security/compliance requirements are then transformed into machine-readable representations having the common data format and that conform to the one or more compliance policies being enforced by the set of security and compliance controls. The one or more compliance policies including the one or more transformed security/compliance requirements are then activated to facilitate the security and regulatory compliance.

### BACKGROUND OF THE INVENTION

### Technical Field

This disclosure relates generally to information technology configured to facilitate compliance to security and regulatory standards in an enterprise computing environment.

### Background of the Related Art

Enterprises are embracing cloud technologies to drive innovation, modernize their Information Technology (IT) infrastructure, and ultimately, digitize their business. When it comes to hosting sensitive and regulated workloads on the public cloud, enterprises —particularly those in highly regulated industries—are required to manage security and compliance consistently and continuously. Regulated industries are often mandated to provide a certain level of observability, traceability and access of how features are delivered and managed in their runtime operational environment. This requires planning, development, testing, and enforcement of policies in the continuous delivery pipeline and in the runtime environment. Auditability of compliance measures is extremely important for proving compliance to third party auditors.

While enterprises are aware of this problem, the challenge is often the effort required to consistently verify and ensure that the right configurations and controls are in place—particularly in an IT environment that is rapidly growing and continuously changing. Manual audits and checks simply do not scale for this, making it imperative that enterprises adopt automation to consistently apply security controls and continuously monitor their security and compliance posture. This problem is exacerbated because different user personas, with skills ranging from legal to business to IT, handle different portions of the end-to-end compliance workflow.

Given the increasing risk and cost of security and compliance violations, combined with the volume of technological and regulatory change, there is a need to provide solutions that enables end-to-end continuous compliance workflow in a way that fosters flexibility, optimization and automation.

### BRIEF SUMMARY

This disclosure provides a method, apparatus and computer program product for modularized governance of compliance in an enterprise computing environment. According to a representative method, a set of security and compliance controls are provided. The set of security and compliance controls are encapsulated in a standardized manner. User-specified or regulation-specified requirements are then collected. User-specified (“bring-your-won” (BYO)) requirements include one or more of: the customer's own controls, profiles, assessment tools, remediation, and GRC (Governance/Risk/Compliance) requirements. Each such requirement is characterized by one or more BYO compliance artifacts. The user-specified or regulation-specified requirements are translated into a machine-readable format. Translation may include transforming the user-specified or regulation-specified requirements from an unstructured format into a set of codified requirements, and mapping the codified requirements to a set of standardized policies supported by enterprise computing environment. The mapped standardized policies are then activated on components (e.g., primitives) within the computing environment, and execution results of these components are then reported to a compliance management application for exposure to interested persons or entities (e.g., Security/Compliance personnel, auditors, and the like).

The foregoing has outlined some of the more pertinent features of the disclosed subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 depicts a representative cloud computing environment;

FIG. 4 depicts a known policy management system for authoring, distributing and enforcing policies;

FIG. 5 depicts a representative cloud-based continuous compliance platform according to one embodiment of this disclosure;

FIG. 6 depict further details of the cloud-based continuous compliance platform;

FIG. 7 depicts an end-to-end workflow associated with the SCC platform 700, which operates as a compliance hub; and

FIG. 8 depicts a process flow depicts various operations that are implemented according to this disclosure to seamlessly integrate a customer's BYO artifacts into a continuous compliance automation ecosystem.

### DETAILED DESCRIPTION

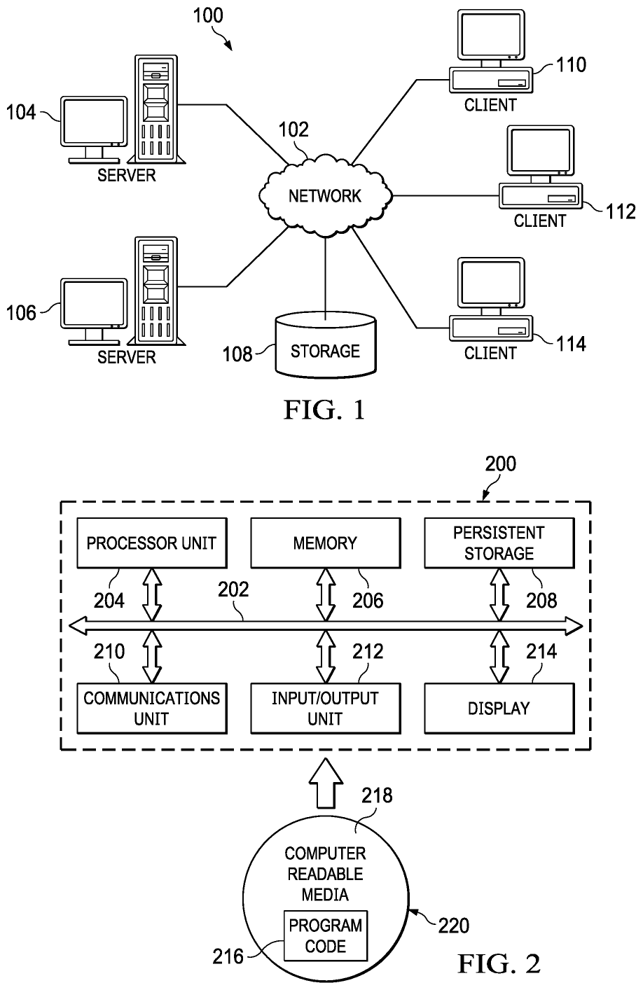

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

### Cloud Computing Model

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

In particular, typical characteristics are on-demand self-service, resource pooling, rapid elasticity, and measured service. The service models typically are: Software as a Service (SaaS), i.e. the capability provided to the consumer is to use the provider's applications running on a cloud infrastructure; Platform as a Service (PaaS), i.e. the capability provided to the consumer is to deploy onto the cloud infrastructure consumer-created or acquired applications created using programming languages and tools supported by the provider; and Infrastructure as a Service (IaaS), i.e. the capability provided to the consumer is to provision processing, storage, networks, and other computing resources where the consumer is able to deploy and run arbitrary software, which can include operating systems and applications. The deployment models typically are: private cloud, wherein the cloud infrastructure is operated solely for an organization; community cloud, wherein the cloud infrastructure is shared by several organizations and supports a specific community that has shared concerns (e.g., mission, security requirements, policy, and compliance considerations); public cloud, wherein the cloud infrastructure is made available to the general public or a large industry group and is owned by an organization selling cloud services; and hybrid cloud, wherein the cloud infrastructure is a composition of two or more clouds (private, community, or public) that remain unique entities but are bound together by standardized or proprietary technology that enables data and application portability.

A representative cloud computing node is as illustrated in FIG. 2 above.

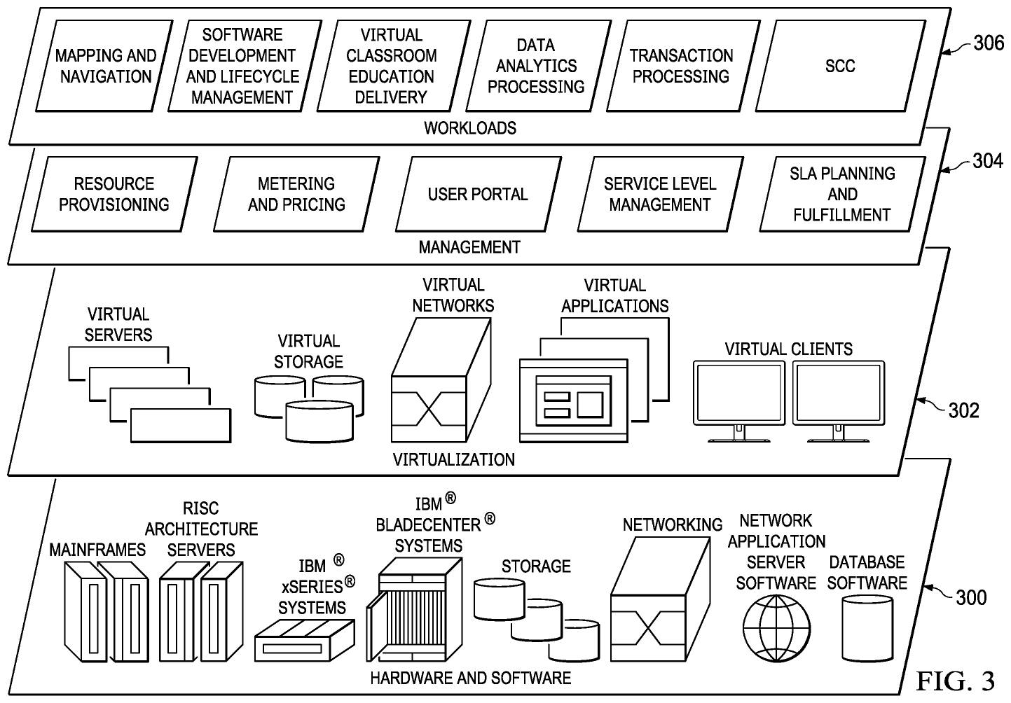

FIG. 3 depicts functional abstraction layers provided by a typically cloud computing environment is shown. Hardware and software layer 300 includes hardware and software components. Virtualization layer 302 provides an abstraction layer from which the following examples of virtual entities may be provided: virtual servers; virtual storage; virtual networks, including virtual private networks; virtual applications and operating systems; and virtual clients. Management layer 304 provides resource provisioning, metering and pricing, security, a portal, service level management, Service Level Agreement (SLA) planning and fulfillment, and the like. The workloads layer 306 provides functionality for which the cloud computing environment may be utilized. Examples of workloads and functions which may be provided from this layer include: mapping and navigation; software development and lifecycle management; virtual classroom education delivery; data analytics processing; transaction processing, and in the context of this disclosure, a security and compliance platform.

As is also known, the notion of “cloud-native” is an approach to building applications that leverage foundational cloud computing technologies. The goal of cloud-native is to enable a consistent and optimal application development, deployment, management and performance across public, private and multi-cloud environments. Today, cloud-native applications are typically built using microservices, deployed in containers, and operated (at scale) using an orchestration platform for scheduling and automating the deployment, management and scaling of containerized applications. Microservices are loosely-coupled, independently deployable components that have their own self-contained stack, and that communicate with each other via REST APIs, event streaming or message brokers. Containers are executable units of code that contain all the code, runtimes and operating system dependencies required to run the application. For most organizations, containers are synonymous with Docker containers, but other container types exist. A representative container orchestration platform is Kubernetes, which is available as open source.

### Policy Definition, Management and Administration

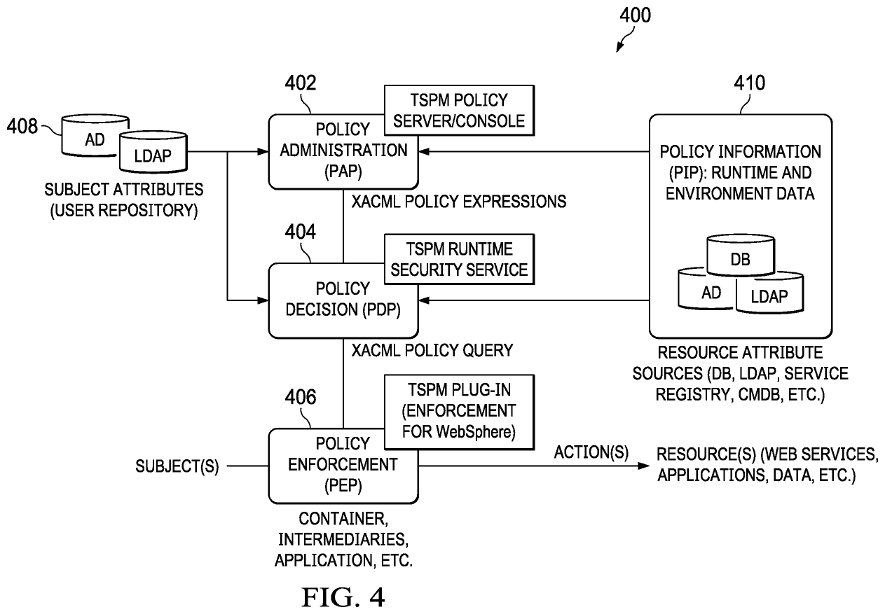

By way of additional background, FIG. 4 illustrates a representative policy management system 400. The system 400 may be implemented across one or more machines operating in a computing environment, such as shown in FIG. 1. Typically, the system comprises a policy administration point (PAP) 402, the policy decision point (PDP) 404, and a policy enforcement point (PEP) 406. Generally, policy administration point 402 is used to define a policy, which may be specified as a set of XACML policy expressions. This policy uses subject attributes provided from a user repository 408, as well runtime and environment data received from policy information point (PIP) 410. The policy decision point (PDP) 404 receives similar information and responds to an XACML policy query received from the policy enforcement point (PEP) 406 to enforce the policy on a subject and with respect to a particular action initiated by the subject. The PDP 404 implements the policy decision. In one commercial implementation of this approach, the PAP 402 is implemented by IBM® Tivoli® Security Policy Manager (TSPM) policy service/console, the PDP 404 is implemented in the TSPM runtime security service, and the PEP is implemented as a TSPM plug-in to application server, such as IBM WebSphere® Application Server.

The policy management system may be implemented using one or more computing machines, such as shown in FIG. 2.

The policy administration point typically includes a web-based user interface by which a policy may be authored and distributed.

### DevOps

By way of additional background, the DevOps lifecycle (sometimes called the continuous delivery pipeline) is a series of iterative, automated development processes, or workflows, executed within a larger, automated and iterative development lifecycle designed to optimize the rapid delivery of high-quality software. The workflows typically includes planning, development, integration, deployment, operations and learning.

In planning, teams scope out new features and functionality in a next release, typically drawing from prioritized end-user feedback and case studies, as well as inputs from all internal stakeholders. The goal in the planning stage is to maximize the business value of the product by producing a backlog of features that when delivered produce a desired outcome that has value.

Development is the programming step, where developers test, code, and build new and enhanced features, e.g., based on user stories and work items in the backlog. A combination of practices such as test-driven development (TDD), pair programming, and peer code reviews, among others are common.

During integration (or build, or continuous Integration and continuous delivery (Cl/CD), the new code is integrated into the existing code base, then tested and packaged into an executable for deployment. Common automation activities include merging code changes into a “master” copy, checking out that code from a source code repository, and automating the compile, unit test and packaging into an executable.

In deployment (usually called continuous deployment), the runtime build output (from integration) is deployed to a runtime environment—usually a development environment where runtime tests are executed for quality, compliance and security. If errors or defects are found, developers have a chance to intercept and remediate any problems before any end users see them. There are typically environments for development, test, and production, with each environment requiring progressively “stricter” quality gates. A good practice for deployment to a production environment is typically to deploy first to a subset of end users, and then eventually to all users once stability is established.

In the operations workflow, feature performance, behavior, and availability are monitored to ensure that the features are able to provide value add to end users. Operations ensures that features are running smoothly and that there are no interruptions in service—by making sure the network, storage, platform, compute and security posture are all healthy. If something goes wrong, operations ensures incidents are identified, the proper personnel are alerted, problems are determined, and fixes are applied.

The learning (or continuous feedback) involves gathering feedback from end users and customers on features, functionality, performance and business value to take back to planning for enhancements and features the next release.

Several important workflows also occur between these workflows, namely, continuous testing, security and compliance. Classical DevOps lifecycles include a discrete “test” phase that occurs between integration and deployment. DevOps, however, has advanced such that certain elements of testing can occur in planning (behavior-driven development), development (unit testing, contract testing), integration (static code scans, CVE scans, linting), deployment (smoke testing, penetration testing, configuration testing), operations (chaos testing, compliance testing), and learning (A/B testing). Testing is a powerful form of risk and vulnerability identification and provides an opportunity for IT to accept, mitigate, or remediate risks.

While waterfall methodologies and agile implementations tack on security workflows after delivery or deployment, DevOps strives to incorporate security from the start (planning)—when security issues are easiest and least expensive to address—and continuously throughout the rest of the development cycle. This approach to security is referred to as shifting left.

Regulatory compliance (governance and risk) are also best addressed early and throughout the development lifecycle. As noted above, regulated industries are often mandated to provide a certain level of observability, traceability and access of how features are delivered and managed in their runtime operational environment. This requires planning, development, testing, and enforcement of policies in the continuous delivery pipeline and in the runtime environment.

### Modularized Governance of Continuous Compliance

With the above as background, the techniques of this disclosure are now described. Without intending to be limited, in one embodiment security and compliance is provided by a cloud-based security and compliance platform where, for example, customers define controls, assess posture, monitor security and compliance, remediate issues, and collect audit evidence. To this end, the cloud platform provides a Security and Compliance Center (SCC) network-accessible dashboard that enables a user (customer) to view and automate its security and compliance postures, to enable configuration governance, and to detect vulnerabilities and threats. For example, the dashboard enables the customer to manage configuration rules that define provisioned resources' rules to standardize configurations, to choose predefined profiles (and associated predefined groups of controls) to ensure best practices, to create and manage custom profiles to select specific controls to meet regulatory standards, to identify anomalies by monitoring network and user behavior, to download results as a report for audit evidence, and to configure custom tools to manage security findings. A representative SCC is IBM Cloud® Security and Compliance Center, although this cloud service is not intended to be limiting. Preferably, any functionality that is exposed as a cloud service, e.g., in a cloud computing environment such as described above with respect to FIG. 3, may be used. In the alternative, the platform functions described herein may execute in a standalone (e.g., on-premises) networking environment.

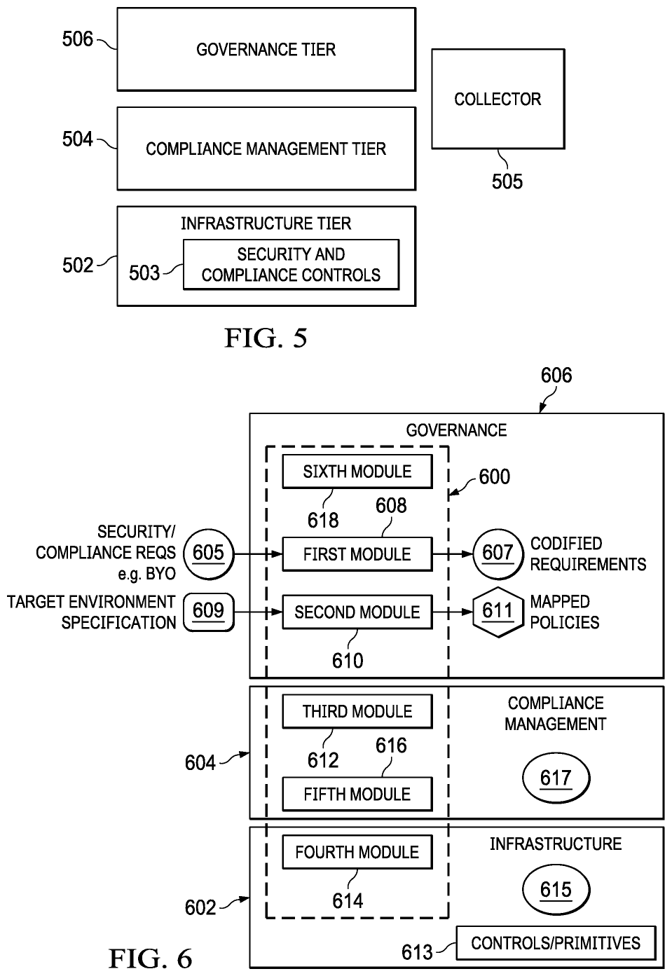

As depicted in FIG. 5, in this embodiment the security and compliance platform 500 comprises three (3) tiers: an infrastructure tier 502, a compliance management tier 504, and a governance tier 506. Typically, the tiers cater to different user personas, e.g., a Security/Compliance Officer, a Security/Compliance Engineer, etc., although this is not a requirement. The infrastructure tier 502 operates as a lowest layer and implements, as primitives, one or more security and compliance controls 503. These implementations are deployable at runtime, or at build time. The compliance management tier 504 preferably sits atop the infrastructure tier 502 and functions to encapsulate one or more security and compliance policies, preferably in a standardized manner, and that are implemented via the primitives (the controls 503) in the infrastructure tier 502. Compliance management tier 504 provides policy management (i.e., it operates as a policy management system, such as described above with respect to FIG. 4). The governance tier 506 operates as a top layer to collect user (customer)-specified or regulation-specified requirements, and translates these requirements into a machine-readable format. While three (3) distinct layers are described, one or more layers may share the above-described functionalities. In general, the three-tier system architecture as described and depicted in FIG. 5 provides a mechanism that connects customer-specified or regulation-specified security and compliance requirements to actual controls (the primitives) implemented in the infrastructure tier 502. As used herein, “customer-specified” security and compliance requirements are sometimes referred to as bring-your-own (BYO) requirements, typically because such requirements either are customer-specific or are otherwise not implemented/available natively in the automation ecosystem.

The security and compliance platform typically also includes additional functionality. One such function is a collector 505, which is used to gather configuration information about the customer's resources and then validate that information against the customer's specified security standards. The collector may be managed by the cloud service provider, or by the customer, and it may have an associated endpoint type, such as public or private. A collector having a public endpoint type stays in constant communication with the cloud service to enable validation of the customer's security and compliance posture. A collector having a private endpoint type communicates with the service through a private endpoint.

FIG. 6 depicts a preferred architecture of the platform in additional detail, once again depicting the infrastructure tier 602, the compliance management tier 604, and the governance tier 606 as in FIG. 5. In particular, and according to this disclosure, modularized governance of compliance is facilitated by a set of modules 600 whose functionality is now described. This compliance is sometimes referred to herein as being “continuous,” although this notion is not meant to require any particular temporal limitation, as the techniques herein may be carried out periodically or upon given occurrences. The set of modules 600 include a first module 608. As depicted, first module 608 is located in the governance tier 606 and operates to transform security/compliance requirements 605 into codified requirements 607. Typically, the security/compliance requirements 605 are available in unstructured or semi-structured documents, or are otherwise collected through user interaction with the system. According to an aspect of this disclosure, the security/compliance requirements may vary and include one or more of: the customer's own controls, profiles, assessment tools, remediation, and GRC (Governance/Risk/Compliance) requirements. Each such requirement is characterized by one or more compliance artifacts. Thus, e.g., the customer may specify its own controls, which have their associated controls artifacts, its own profiles, which have their associated profiles artifacts, and so forth. As will be described, the platform of this disclosure enables these user-specified requirements to be integrated into the continuous compliance processing provided by the platform in a seamless and automated manner.

Referring back to FIG. 6, a second module 610 is also located in the governance tier 606 accepts the codified requirements 607, together with information 609 about one or more target environments in the enterprise computing environment, and maps the codified requirements to one or more standardized policies 611 that are supported by the compliance management tier 604 for each target environment. As also shown in FIG. 6, a third module 612 located in the compliance management tier 604 takes the mapped policies 611 and activates them in the target environment, preferably through one or more controls (primitives) 613 available in the infrastructure tier 602. The type and nature of the security controls 613 vary depending on the compliance posture at issue. For example, and without limitation, the security controls may be NIST 800-53 security controls. The NIST 800-53 standards and guidelines provide a comprehensive set of security controls, and many state and federal organizations implement this framework to help ensure the security and privacy of governmental infrastructures and data they manage. According to this standard, the security controls are defined by control groups, such as AC (Access Control), AT (Awareness and Training), AU (Audit and Accountability), CM (Configuration Management), and many more. Although not intended to be limiting, control-based information typically is expressed in an SCC operating environment using OSCAL (Open Security Controls Assessment Language), which is a set of formats expressed in XML, JSON and YAML. OSCAL was developed by NIST and provide machine-readable representations of control catalogs, control baselines, system security plans, and assessment plans and results. Control-based information expressed using OSCAL formats enables easy access of control information from security and privacy control catalogs, the sharing of machine-readable control baselines, maintaining and sharing actionable, up-to-date information about how controls are implemented in the customer's systems, and automating monitoring and assessment of the effectiveness of the customer s controls. The OSCAL format is not intended to be limiting, as other data or Compliance as Code formats ay be used.

Referring back to FIG. 6, a fourth module 614 located in the infrastructure tier 602 executes the activated control(s) 613 on one or more components in the target environment. The fourth module 614 also reports back results 615 to the compliance management tier 604. A fifth module 616 within the compliance management tier 604 aggregates results 615 for each of the target environments and reports those aggregated results 617 back to the governance tier 606. The fifth module 616 also stores raw data results in an associated archive (not shown). Finally, a sixth module 618 within the governance tier 606 collects the aggregated results and reports back in an automated manner to the customer or regulator against one or more specified requirements. The reporting provided by the sixth module may be customized according to a customer's BYO reporting requirements.

The modules 608, 610, 612, 614, 616 and 618 typically comprise computer software executed in one or more hardware processors. Modules that operate within a particular tier may be combined with one another, although typically these modules execute as different processes, execution threads, or native code. The modules preferably use NIST standard OSCAL language to define their data model format and exchange.

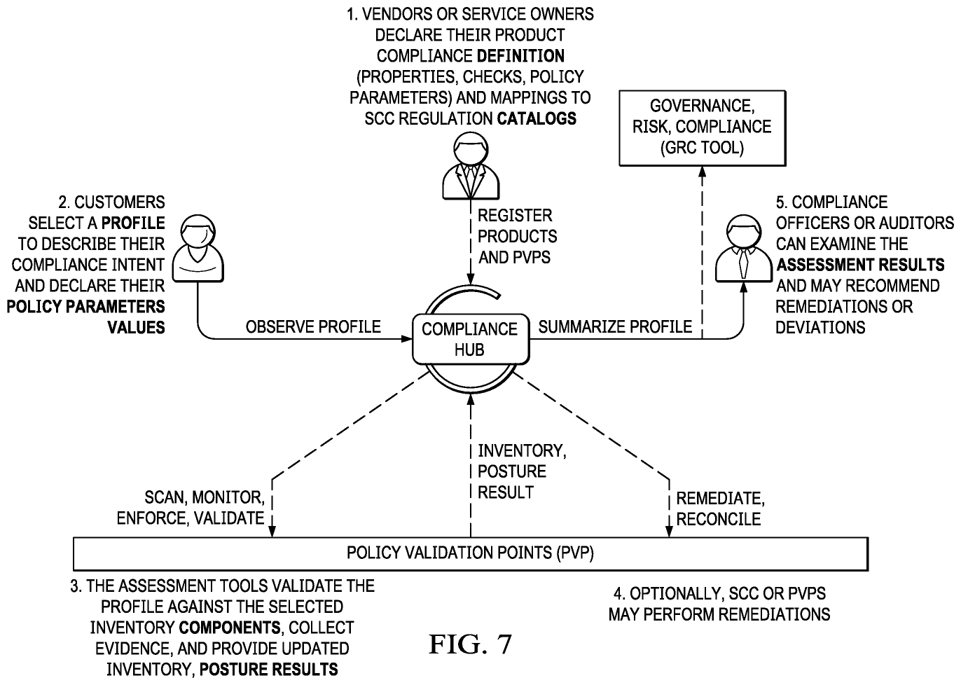

FIG. 7 depicts a conventional end-to-end workflow associated with the SCC platform 700, which operates as a compliance hub. As described above, preferably the SCC platform exposing a network-accessible dashboard, and data formats and exchanges conform to the OSCAL language. At step (1), vendors or service owners declare to the SCC one or more product compliance definitions (e.g., properties, checks, policy parameters, etc.), and one or more mappings to SCC regulation catalogs. At step (2), customers select a profile to describe their compliance intent and to declare their policy parameter(s) values. This enables the compliance hub to observe and manage the profile of interest. At step (3), and using one or more Policy Validation Points (PVPs), one or more assessment tools validate the profile and actively manage security and compliance against selected inventory components, and in the process collect evidence, providing updated inventory and posture results, and the like. A representative PVP is a toolchain, namely, a set of tool integrations that support development, deployment, and operations tasks. At step (4), the SCC or PVPs perform remediations or other reconciliations. At step (5), the compliance hub summarizes the compliance posture at issue, enabling interested persons (e.g., compliance officers and auditors) to examine assessment results. As noted above, the compliance posture may be set forth in an audit report, e.g., supporting evidence, possibly customized according to a BYO requirement. Based on the results, remediations or deviations may be recommended. Step (5) may leverage a Governance/Risk/Compliance (GRC) tool.

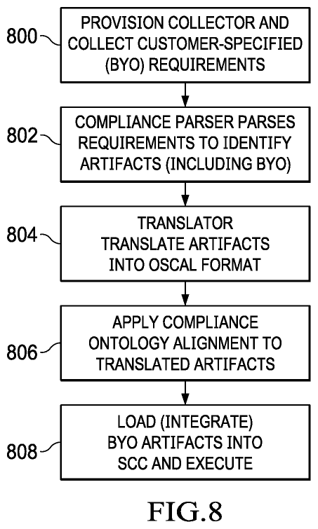

The conventional end-to-end continuous compliance processing as depicted in FIG. 7 is augmented according to this disclosure to enable the system to seamlessly integrate customer-specified requirements and their associated artifacts, To this end, the following provides additional details regarding specialized functions that are provided by one or more of the modules 608, 610, 612, 614 and 618 depicted in FIG. 6. In particular, and with reference to the process flow in FIG. 8, these operations are now described.

At step 800, an endpoints collector is configured and used to collect customer-specified requirements. These may include new controls references specified by a Compliance Officer, compliance definition references associated with a vendor's new products or services, references associated with new assessment or GRC tools, and the like. Endpoints collector may also operate at this step to acquire the customer's new profiles or baselines definition references. Generalizing, the endpoints collector collects information from one or more of the customer's: BYO (bring-your-own) controls, profiles, assessment tools, remediation tools, and GRC tools. At step 802, the information collected by the endpoints collector is processed by a compliance parser. In this operation, the parser identifies BYO artifacts (e.g., Swager API arguments, XML or YAML objects and tags, plug-in configurations, etc.) associated with the customer's controls, profiles assessment tools, remediation tools, or GRC tools that were identified by the collector. The type and nature of the BYO artifacts identified by the parser vary depending on implementation. At step 804, the output of the compliance parser (namely, the parsed artifacts) are translated into the OSCAL format. Preferably, the translator function operates based on the #D ontology concept classes, and it preserves original endpoint namespaces. Thus, and at step 804, the customer's BYO controls artifacts are translated into a catalog format, the customer's BYO profile artifacts are translated into a profile format, the customer's BYO assessment artifacts are translated to a result format, and the customer's BYO GRC artifacts are translated to GRC formats. At step 806, the translated parsed BYO artifacts are then subject to a compliance ontology alignment, which aligns the module concepts with existing industry artifacts. The nature of the alignment will vary depending on the implementation (and the artifact), but typically this operation augments the parsed artifact with one or more predefined parsed parameters or parameter values, sub-controls or control priorities, findings, etc. As an example, typically an assessment result object checks if an observation object (i.e., a pass/fail policy) has an associated finding object (i.e., the impacted regulation control that will pass/fail). If step 806 determines that the finding object is not present in the customer's parsed artifact, the alignment operation automatically augments to the customer's parsed artifact to include it (e.g., using a vendor product mapping). For the customer's control artifact, augmentation may involve adding a parsed parameter, a sub-control or a section. For the customer's profile artifact, augmentation may involve adding a parsed parameter value, or a control priority. For the customer's result artifact, augmentation may involve adding a parsed finding, remediation or deviation. These are just representative, non-limiting examples.

Referring back to FIG. 8, the process continues at step 808 to load (integrate) the BYO artifacts, which have been parsed (step 802), translated (step 804) and enhanced (step 806), into the SCC modularized architecture. In particular, step 808 points or otherwise associates the BYO artifact references (typically HREFs, or APIs) into their corresponding SCC modules files or databases. This operation completes the BYO artifact integration to facilitate the SCC continuous compliance automation.

The above-described processes in FIG. 8 typically are carried out in the first and second modules depicted in FIG. 6. Each of the described operations (e.g., parsing 802, translation 804, augmentation 806, etc.) preferably are implemented as a microservice. In particular, each such operation executes within a cloud container as a microservice, and each component operates independently from the other(s).

The technique of this disclosure provides significant advantages. Foremost, it enables the continuous compliance processing to be extended to support the scenario wherein a customer brings their own compliance artifacts into the continuous compliance automation ecosystem. The BYO artifact support is enabled in a seamless, reliable and scalable manner. As noted above, preferably the techniques herein are performed in a cloud computing environment (FIG. 3), or otherwise leverage cloud-compute resources.

Any of the endpoint, parser, translation, augmentation and/or loader functionality described above may be implemented as a standalone approach, e.g., a software-based function executed by a processor, or it may be available as a managed service (including as a web service via a SOAP/XML interface). The particular hardware and software implementation details described herein are merely for illustrative purposes are not meant to limit the scope of the described subject matter.

The techniques herein are not limited to use with a microservices-based application, although this type of application implementation benefits significantly from the approach. Indeed, the approach benefits any application implementation that performs authorization including, without limitation, those based on monolithic models, object-oriented models, and others.

More generally, computing devices within the context of the disclosed invention are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, SAML, WS-Trust, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures other than cloud-based infrastructures. These include, without limitation, simple n-tier architectures, web portals, federated systems, and the like.

Still more generally, the subject matter described herein can take the form of an entirely hardware embodiment, an entirely software embodiment or an embodiment containing both hardware and software elements.

Furthermore, the user impersonation/delegation functionality described herein can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, one or more of the modules or runtime-based components are implemented in a special purpose computer, preferably in software executed by one or more processors. The software also is maintained in one or more data stores or memories associated with the one or more processors, and the software may be implemented as one or more computer programs.

The SCC functionality may be implemented as an adjunct or extension to an existing security (authentication) service, or access manager solution. The technique also may be implemented in an automated manner, as has been described.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

The techniques herein provide for improvements to another technology or technical field, e.g., continuous compliance of security and regulatory requirements, microservices, and policy management systems.

What is claimed is as follows.

1. A method for automated security and regulatory compliance in association with an enterprise, comprising:
providing a set of security and compliance controls;
encapsulating one or more compliance policies according to a common data format, the one or more compliance policies enforced by the set of security and compliance controls;
collecting one or more security or compliance requirements associated with the enterprise;
transforming the one or more security or compliance requirements into machine-readable representations having the common data format and that conform to the one or more compliance policies being enforced by the set of security and compliance controls; and
activating the one or more compliance policies including the one or more transformed security or compliance requirements to facilitate the security and regulatory compliance.

2. The method as described in claim 1 wherein the one or more security or compliance requirements are at least one of: an enterprise security and compliance control, an enterprise profile, an enterprise assessment tool, an enterprise remediation tool, and an enterprise Governance/Risk/Compliance (GRC) tool.

3. The method as described in claim 1 wherein transforming the one or more security or compliance requirement includes:
parsing at least one security or compliance requirement to identify an artifact;
translating the artifact into the common data format; and
augmenting the translated artifact to include information associated with an existing artifact.

4. The method as described in claim 3 wherein the parsing, translating and augmenting are implemented as microservices.

5. The method as described in claim 1 wherein the common data format is Open Security Controls Assessment Language (OSCAL).

6. The method as described in claim 1 wherein the security and compliance controls are deployed at one of: build time, and runtime.

7. The method as described in claim 1 wherein the compliance policies enforce one or more regulation-specified requirements.

8. Apparatus, comprising:
at least one hardware processor;
computer memory holding computer program instructions executed by the at least one hardware processor for automated security and regulatory compliance in association with an enterprise, the computer program instructions comprising program code configured to:
provide a set of security and compliance controls;
encapsulate one or more compliance policies according to a common data format, the one or more compliance policies enforced by the set of security and compliance controls;
collect one or more security or compliance requirements associated with the enterprise;
transform the one or more security or compliance requirements into machine-readable representations having the common data format and that conform to the one or more compliance policies being enforced by the set of security and compliance controls; and
activate the one or more compliance policies including the one or more transformed security or compliance requirements to facilitate the security and regulatory compliance.

9. The apparatus as described in claim 8 wherein the one or more security or compliance requirements are at least one of: an enterprise security and compliance control, an enterprise profile, an enterprise assessment tool, an enterprise remediation tool, and an enterprise Governance/Risk/Compliance (GRC) tool.

10. The apparatus as described in claim 8 wherein the program code configured to transform the one or more security or compliance requirements includes program code further configured to:
parse at least one security/compliance requirement to identify an artifact;
translate the artifact into the common data format; and
augment the translated artifact to include information associated with an existing artifact.

11. The apparatus as described in claim 10 wherein the parsing, translating and augmenting are implemented as microservices.

12. The apparatus as described in claim 8 wherein the common data format is Open Security Controls Assessment Language (OSCAL).

13. The apparatus as described in claim 8 wherein the security and compliance controls are deployed at one of: build time, and runtime.

14. The apparatus as described in claim 8 wherein the compliance policies enforce one or more regulation-specified requirements.

15. A computer program product in a non-transitory computer-readable medium for use in a data processing system, the computer program product holding computer program instructions executed by the data processing system for automated security and regulatory compliance in association with an enterprise, the computer program instructions comprising program code configured to:
provide a set of security and compliance controls;
encapsulate one or more compliance policies according to a common data format, the one or more compliance policies enforced by the set of security and compliance controls;
collect one or more security or compliance requirements associated with the enterprise;
transform the one or more security or compliance requirements into machine-readable representations having the common data format and that conform to the one or more compliance policies being enforced by the set of security and compliance controls; and
activate the one or more compliance policies including the one or more transformed security or compliance requirements to facilitate the security and regulatory compliance.

16. The computer program product as described in claim 15 wherein the one or more security or compliance requirements are at least one of: an enterprise security and compliance control, an enterprise profile, an enterprise assessment tool, an enterprise remediation tool, and an enterprise Governance/Risk/Compliance (GRC) tool.

17. The computer program product as described in claim 15 wherein the program code configured to transform the one or more security or compliance requirements includes program code further configured to:
parse at least one security/compliance requirement to identify an artifact;
translate the artifact into the common data format; and
augment the translated artifact to include information associated with an existing artifact.

18. The computer program product as described in claim 17 wherein the parsing, translating and augmenting are implemented as microservices.

19. The computer program product as described in claim 15 wherein the common data format is Open Security Controls Assessment Language (OSCAL).

20. The computer program product as described in claim 15 wherein the security and compliance controls are deployed at one of: build time, and runtime.

21. The computer program product as described in claim 15 wherein the compliance policies enforce one or more regulation-specified requirements.

22. The method as described in claim 1 wherein activating the one or more compliance policies includes:
executing at least one of the security and compliance controls;
monitoring results of executing the at least one security and compliance control; and
based on the monitoring, issuing or filtering an audit report on a compliance posture of the enterprise.

23. The apparatus as described in claim 8 wherein the program code configured to activate the one or more compliance policies includes program code further configured to:
execute at least one of the security and compliance controls;
monitor results of executing the at least one security and compliance control; and
based on the monitoring, issue or filter an audit report on a compliance posture of the enterprise.

24. The computer program product as described in claim 15 wherein the program code configured to active the one or more compliance policies includes program code further configured to:
execute at least one of the security and compliance controls;
monitor results of executing the at least one security and compliance control; and
based on the monitoring, issue or filter an audit report on a compliance posture of the enterprise.
